(19) United States
(12) Patent Application Publication
(10) Pub. No.: US 2001/0040229 A1
(43) Pub. Date: Nov. 15, 2001

(54) Air intake assembly for an internal combustion engine

(76) Inventor: Thomas Schroder, Berlin (DE)

Correspondence Address: JULIAN H. COHEN, Ladas & Parry, 26 West 61st Street, New York, NY, 10023, US

(21) Appl. No.: 09/745,625

(22) Filed: Dec. 21, 2000

(30) Foreign Application Priority Data
Dec. 23, 1999 (DE) 199 62 733.9

(51) Int. Cl. F16K 5/02; F02D 9/08

(52) U.S. Cl. 251/309

(57) ABSTRACT

An air intake assembly for internal combustion engines, in which a throttle valve unit is inserted into a casing molded in one piece with an air inlet leading to an air filter of the engine. The casing and the throttle valve unit have complementary tapered portions which are sealed when the throttle valve unit is inserted into the casing. An opening in the casing is surrounded by O-ring seals which seal a bore in the throttle valve unit extending to a valve secured to a rotatable shaft.

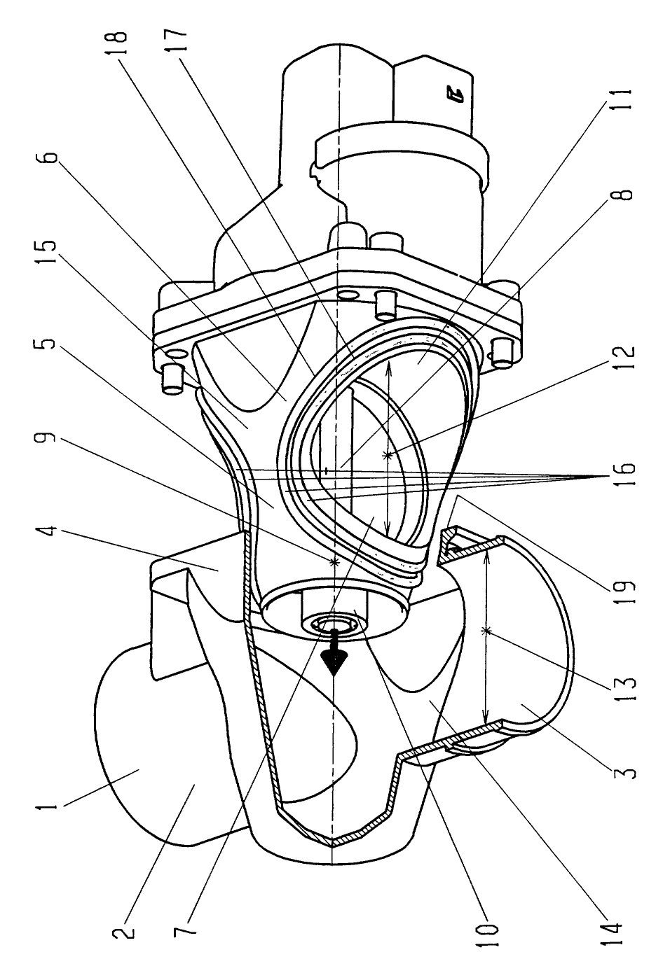

### FIELD OF THE INVENTION

The invention relates to an air intake assembly for an internal combustion engine having an inlet portion which extends to an air filter and a throttle valve unit to supply air to the inlet portion.

### BACKGROUND AND PRIOR ART

Such devices are known in the art. Due to the diversity of vehicles and associated installations, the shape of the intake tube assembly must be adapted to match the respective circumstances. This also necessitates adaptation of the throttle valves used which, depending on the structure of the intake tube assembly are provided with different flange shapes or differently configured couplings on the air-filter side, even if the valve diameters are equal.

German Patent DE 1980335 A1 teaches how to construct the inlet tube such that it is intersected perpendicular to its axis by an integral casing larger in diameter than the diameter of the inlet tube, the length of the casing being such that a throttle valve unit can be inserted therein and fixedly secured in sealed relation. It has been determined, however, that this construction exhibits relatively large air leaks, and hence, the minimum attainable air flow, when the throttle valve is closed, is greater than that of an air intake tube with a throttle valve fixed therein. This results from an additional leakage air flow, which takes place through a clearance gap between the casing and the inserted throttle-valve unit.

### SUMMARY OF THE INVENTION

An object of the invention is to provide means for preventing this additional air leakage while retaining the concept of an intake tube assembly that permits the most widespread possible use of a uniform throttle-valve unit.

This object is achieved by an air intake assembly for an internal combustion engine, in which said air intake assembly comprises a tubular inlet section having an air collection portion, and an inlet portion adapted for being connected to an air filter, and an integral air delivery section having a casing molded in one piece with said tubular section and extending perpendicularly thereto, a throttle valve unit being inserted into said casing section, the casing having a rotationally symmetrical contour. The throttle valve unit includes a body, a shaft supported by said body for rotation about an axis extending perpendicular to said tubular section, and a throttle valve secured to said shaft, said body having a bore in which said throttle valve is disposed to control admission of air to said air inlet section via said bore. The bore extends perpendicularly to said axis of rotation of said shaft. The inlet portion of said air inlet section and said bore have substantially equal diameters. The casing of said air delivery section and said body of said throttle valve unit are of complementary shape so as to conform to one another when said throttle valve unit is inserted into said casing.

According to a feature of the invention, said casing has an opening aligned with said bore when said throttle valve unit is inserted into said casing, said casing being provided with O-ring seals surrounding said opening which are elastically deformed by said body of said throttle valve unit upon its insertion into said casing.

According to a further feature of the invention, said O-ring seals are spaced apart from one another.

According to a further feature of the invention, said O-ring seals are placed in grooves provided in said casing.

According to a further feature of the invention, the material of the O-ring seals is injected into the grooves and cured to form said O-ring seals in situ.

According to a further feature of the invention, said air delivery section has a stop against which the throttle valve unit bears when inserted into position in the air delivery section.

### BRIEF DESCRIPTION OF THE DRAWING

The sole FIGURE of the drawing is a diagrammatic, respective view of an air intake assembly according to the invention, partly broken away and in section.

### DETAILED DESCRIPTION

The drawing shows an air intake assembly for an internal combustion engine having a tubular section 1 with an inlet portion 3 which extends from a collecting portion 2 to an air filter (not shown) of the engine. The tubular section is intersected perpendicular to its axis by an integral casing 4 molded in one piece with the tubular section 1. The casing 4 serves as part of an air delivery section and has a length sufficient to receive a throttle valve unit 5 which is inserted into the casing 4 and is sealed and secured therein. The casing 4 has a rotationally symmetrical outside contour 6. The throttle valve unit is provided with a shaft 8 supporting a throttle valve 7. The throttle valve unit 5 has a body with portions 10 supporting shaft 8 for rotation about an axis 9. The throttle valve 7 is disposed in a bore 11 in the body of the throttle valve unit and the bore extends perpendicular to the axis 9 of rotation of the shaft. The bore 11 has a diameter 12 substantially equal to the diameter 13 of inlet portion 3. When the throttle valve unit is inserted into the casing 4, the bore 11 is aligned with an opening in the casing to admit air into the bore 11 under the control of the throttle valve 7. The casing 4 and the body of throttle valve unit 5 have complementary tapered portions 14 and 15 which permit the throttle valve unit 5 to be inserted into casing 4 without any scraping contact of portions 14 and 15. In an advantageous embodiment, portion 15 is provided with a plurality of O-ring-type seals 16, which seal the body of the throttle valve unit and casing 4 and which surround bore 11 and deform elastically when the throttle valve unit 5 is inserted into casing 4. Thereby, there is achieved resilient cushioned retention of the throttle valve unit 5 inside the portion 14 of casing 4, in combination with highly effective sealing. Furthermore, the O-ring-type seals 16 cannot be damaged by the edges of the complementary surfaces of the casing and the body as they both taper in the direction of insertion of the throttle valve unit into the casing.

These effects can be further improved by providing two or more O-ring seals 16 spaced from one another around the bore 11, so that labyrinths 17, which function as additional sealing means, are formed between O-ring seals 16.

The O-ring seals 16 are placed in grooves 18 provided in portion 15 of casing 4 or are injected as liquid material into the grooves and cured in situ.

The inserted throttle valve unit 5 bears against an axial stop 19 in the form of a flange face, and consequently there can be obtained between the walls of portion 14 of casing 4 and the portion 15 of the body of the throttle valve unit, a clearance gap which is identical for each air intake assembly and which produces precisely the same deformation of the O-ring seals 16. Consequently, a high level of sealing between the casing 4 and the body of the throttle valve unit is obtained to thereby prevent air leaks while providing effective cushioning.

Although the invention is disclosed with reference to particular embodiments thereof, it will become apparent to those skilled in the art that numerous modifications and variations can be made which will fall within the scope and spirit of the invention as defined by the attached claims.

What is claimed is:

1. An air intake assembly for an internal combustion engine, said air intake assembly comprising a tubular section having a collection portion, an inlet portion adapted for being connected to an air filter, and an integral air delivery section including a casing molded in one piece with said tubular section and extending perpendicularly thereto and a throttle valve unit inserted into said casing, said casing having a rotationally symmetrical contour, said throttle valve unit including a body, a shaft supported by said body for rotation about an axis extending perpendicular to said tubular section, and a throttle valve secured to said shaft, said body having a bore in which said throttle valve is disposed to control admission of air to said inlet portion via said bore, said bore extending perpendicularly to said axis of rotation of said shaft, said inlet portion and said bore having substantially equal diameters, said casing of said air delivery section and said body of said throttle valve unit being of complementary tapered shape so as to conform to one another when said throttle valve unit is inserted into said casing of said air delivery section.

2. The air intake assembly according to claim 1, comprising elastic seals between said body and said casing to seal the body in said casing when the throttle valve unit is inserted into said casing.

3. The air intake assembly according to claim 1, wherein said casing has an opening aligned with said bore when said throttle valve unit is inserted into said casing, said casing having O-ring seals surrounding said opening which are elastically deformed by said body of said throttle valve unit upon its insertion into said casing of said air delivery section.

4. The air intake assembly according to claim 3, wherein said O-ring seals are spaced apart from one another.

5. The air intake assembly according to claim 3, wherein said O-ring seals are placed in grooves provided in said casing of said air delivery section.

6. The air intake assembly according to claim 3, wherein said casing is provided with grooves into which material is injected and cured to form said O-ring seals.

7. The air intake assembly according to claim 1, wherein said air delivery section includes a stop against which said throttle valve unit bears when inserted into position in said air delivery section.

8. The air intake assembly according to claim 7, wherein said complementary portions of said casing and said body are spaced apart by a determined spacing when the throttle valve unit is inserted bears against said stop, and seal rings between said casing and said body which are elastically deformed when said throttle valve body is inserted into said casing and bears against said stop.
